(19) United States
(12) Patent Application Publication
(10) Pub. No.: US 2022/0267166 A1
(43) Pub. Date: Aug. 25, 2022

(54) OXYHALIDE LITHIUM-ION CONDUCTOR

(71) Applicant: Toyota Motor Engineering & Manufacturing North America, Inc., Plano, TX (US)

(72) Inventors: Shingo Ota, Ann Arbor, MI (US); Ryuta Sugiura, Ann Arbor, MI (US); Timothy S. Arthur, Ann Arbor, MI (US); Nikhilendra Singh, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/732,736

(22) Filed: Apr. 29, 2022

(51) Int. Cl. C01G 49/10; H01M 10/0562; H01M 10/0525

(52) U.S. Cl. CPC C01G 49/10; H01M 10/0562; H01M 10/0525; H01M 2300/008

(57) ABSTRACT

A lithium-ion conductor includes an inorganic compound with a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25. Also, the inorganic compound has or exhibits a thermal decomposition temperature greater than 390° C., an ionic conductivity greater than about 1.0×10⁻⁴ S/cm at 25° C., and has a crystal structure that reflects or exhibits x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°.

### TECHNICAL FIELD

The present disclosure generally relates to ionic conductors, and particularly to lithium-ion conductors.

### BACKGROUND

Solid-state inorganic electrolytes provide many advantages in secondary battery design, including mechanical stability, no volatility, and ease of construction. However, H₂S gas can be generated during decomposition of traditional sulfide solid-state inorganic electrolytes and traditional oxide solid-state inorganic electrolytes can have issues with formability due to hardness of the oxide.

The present disclosure addresses these issues with solid-state inorganic electrolytes, and other issues related to solid-state ionic conductors.

### SUMMARY

In one form of the present disclosure, a lithium-ion (Li-ion) conductor includes an inorganic compound with a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25. Also, the inorganic compound has a crystal structure that reflects or exhibits x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°.

In another form of the present disclosure, a Li-ion conductor includes an inorganic compound with a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25. Also, the inorganic compound has or exhibits a thermal decomposition temperature greater than 390° C. and has a crystal structure that reflects or exhibits x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°.

In still another form of the present disclosure, a Li-ion conductor includes an inorganic compound with a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25. Also, the inorganic compound has or exhibits a thermal decomposition temperature greater than 390° C., an ionic conductivity greater than about 1.0×10⁻⁴ S/cm at 25° C., and has a crystal structure that reflects or exhibits x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°.

These and other features of the nearly solvent-free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is a flow chart for a method of synthesizing a Li-ion conductor according to the teachings of the present disclosure;

FIG. 2 is a flow chart for a method of synthesizing an inorganic oxychloride ionic conductor according to the teachings of the present disclosure;

FIG. 3 is a plot of intensity versus angle 2θ for an x-ray diffraction (XRD) scan of an inorganic oxychloride ionic conductor according to the teachings of the present disclosure;

FIG. 4 is an Arrhenius plot of cationic conductivity versus temperature for a Li-ion conductor according to the teachings of the present disclosure and cationic conductivity versus temperature for the traditional Li-ion conductor Li₃OCl; and

FIG. 5 shows a positive electrode coating layer containing a Li-ion conductor according to the teachings of the present disclosure.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

The present disclosure provides inorganic Li-ion conductors with iron, oxygen, and chlorine. The inorganic Li-ion conductors (also referred to herein simply as “Li-ion conductors” and “Li-ion conductor”) have a composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25. In addition, the Li-ion conductors according to the teachings of the present disclosure provide a solid-state electrolyte and/or a positive electrode coating layer with increased ionic conductivity compared to solid-state electrolytes and/or positive electrode coating layers without the composition noted above.

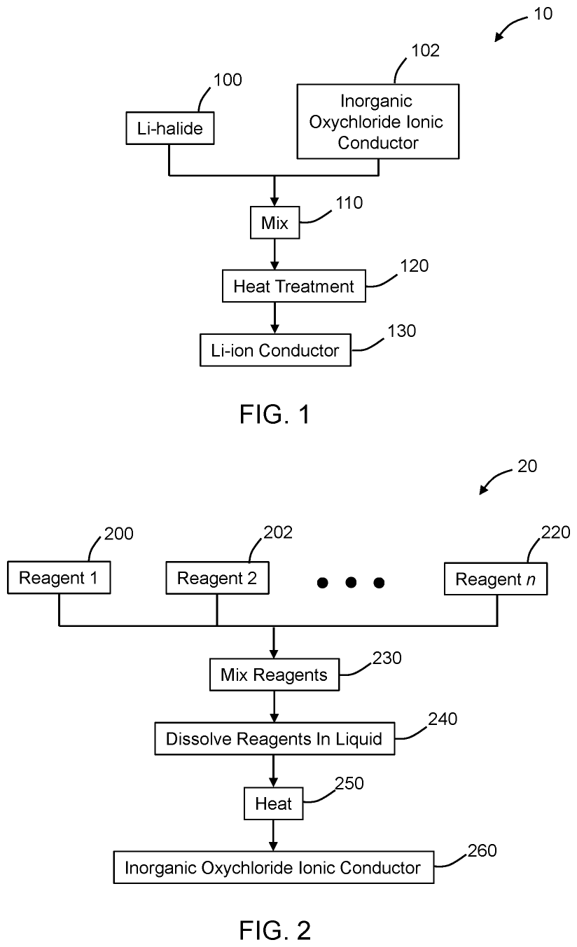

Referring to FIG. 1, a flow chart for one non-limiting method 10 of synthesizing a Li-ion conductor according to the teachings of the present disclosure is shown. The method 10 includes mixing a Li salt or Li-halide 100 with an inorganic oxychloride ionic conductor 102 at 110. In some variations, the Li-halide is a Li-chloride, e.g., LiCl. In other variations, the Li-halide is a mixture of LiCl and a Li-fluoride, e.g., LiF. And in at least one variation the inorganic oxychloride ionic conductor is doped FeOCl in the form of (Fe₁₋ₓMₓ)O_{1-y}(OH)_{y}Cl₁₋ₓ as described below.

The mixture of the Li-halide and inorganic oxychloride ionic conductor are heat treated at 120 such that the Li-ion conductor is formed at 130. In some variations the mixture of the Li-halide and inorganic oxychloride ionic conductor are heated to temperatures above 100° C. for time periods greater than 12 hours.

Referring now to FIG. 2, a flow chart for one non-limiting method 20 of synthesizing the inorganic oxychloride ionic conductor 102 in FIG. 1 according to the teachings of the present disclosure is shown. The method 20 includes mixing two of more chloride containing reagents 200, 202, . . . 220 at 230. In some variations, the chloride containing reagents 200, 202, . . . 220 are in the form of powders that are mechanically mixed together. And in at least one variation, the chloride containing reagents 200, 202, . . . 220 include one or more chlorides of iron (Fe) mixed with one or more chlorides of Mg and/or Ca. For example, in some variations powders of FeCl₃, MgCl₂ and/or CaCl₂ are mechanically mixed at 230 using a mortar and pestle and/or a ball mill such that a mechanical mixture of the FeCl₃, MgCl₂ and/or CaCl₂ powders is formed.

The mixture of the chloride containing reagents 200, 202, . . . 220 are dissolved in a liquid to form a mixed chloride liquid solution at 240. The liquid can be any liquid in which the chloride containing reagents (e.g., FeCl₃, MgCl₂ and/or CaCl₂) powders dissolve, e.g., deionized water.

Heat is applied to the mixed chloride liquid solution at 250 such that an inorganic oxychloride precipitates out of the mixed chloride solution and forms particles of the inorganic oxychloride at 260. In some variations, the mixed chloride liquid solution is heated to a temperature above 100° C., for example above 200° C. In variations where powders of one or more chlorides of Fe are mixed with powders of one or more chlorides of Mg and/or Ca, doped FeOCl in the form of (Fe₁₋ₓMₓ)O_{1-y}(OH)_{y}Cl₁₋ₓ precipitates out of the mixed chloride solution and forms particles of the (Fe₁₋ₓMₓ)O_{1-y}(OH)_{y}Cl₁₋ₓ at 260, where x is greater than 0 and less than or equal to 0.25, y is greater than or equal to 0 and less than or equal to 0.25.

In some variations, the mixed chloride liquid solution is heated in a container (e.g., a glass beaker) until most or all of the liquid evaporates and precipitated particles of the inorganic oxychloride (e.g., (Fe₁₋ₓMₓ)O_{1-y}(OH)_{y}Cl₁₋ₓ) remain in the container. In other variations, the mixed chloride liquid solution is poured onto a heated surface such that the liquid evaporates and precipitated particles of the inorganic oxychloride remain on the heated surface. It should be understood that the precipitated particles of the inorganic oxychloride can be ground using a mortar and pestle and/or a ball mill to ensure uniform inorganic oxychloride particle size and/or uniform chemical composition throughout the inorganic oxychloride.

In order to further describe the teachings of the present disclosure, but not limit scope thereof in any manner, one non-limiting example of synthesizing an inorganic oxychloride ionic conductor and one example of synthesizing a Li-ion conductor according to the teachings of the present disclosure are provided below.

### EXAMPLE 1

### Synthesis of Inorganic Oxychloride Ionic Conductor

Predefined portions of commercial reagent powders of FeCl₃, MgCl₂ and CaCl₂ were weighed in an argon (Ar) glove box with a dew point of about −90° C. The weighed portions of the FeCl₃, MgCl₂ and CaCl₂ powders were mixed together using a mortar and pestle and then dissolved in deionized water to form a mixed chloride liquid solution by pouring the mixed powders of FeCl₃, MgCl₂ and CaCl₂ into a beaker containing the deionized water, and then placing the beaker in an ultrasonic cleaner. After the mixed powders of FeCl₃, MgCl₂ and CaCl₂ were dissolved in the deionized water, the mixed chloride liquid solution was slowly poured into a glass beaker heated to about 200-300° C., which resulted in the evaporation of the deionized water and precipitation of dark red (Fe₁₋ₓMₓ)O_{1-y}(OH)_{y}Cl₁₋ₓ particles at the bottom of the glass beaker.

### EXAMPLE 2

### Synthesis of Li-Ion Conductor and Electrochemical Cells with the Li-Ion Conductor

Powder of LiCl was mixed with powder of (Fe₁₋ₓMₓ)O_{1-y}(OH)_{y}Cl₁₋ₓ formed in Example 1 and heat treated at about 230° C. for about 40 hours in an Ar atmosphere to form powders of the ionic conductor Li_{2-3x+y-z}FeₓO_{y}(OH)_{1-y}Cl_{1-z}. The powders of the Li-ion conductor were compressed into cylindrical pellets using uni-axial pressure and the cylindrical pellets were sandwiched between electrodes in the form of 0.05 mm thick gold foil to form electrochemical cells.

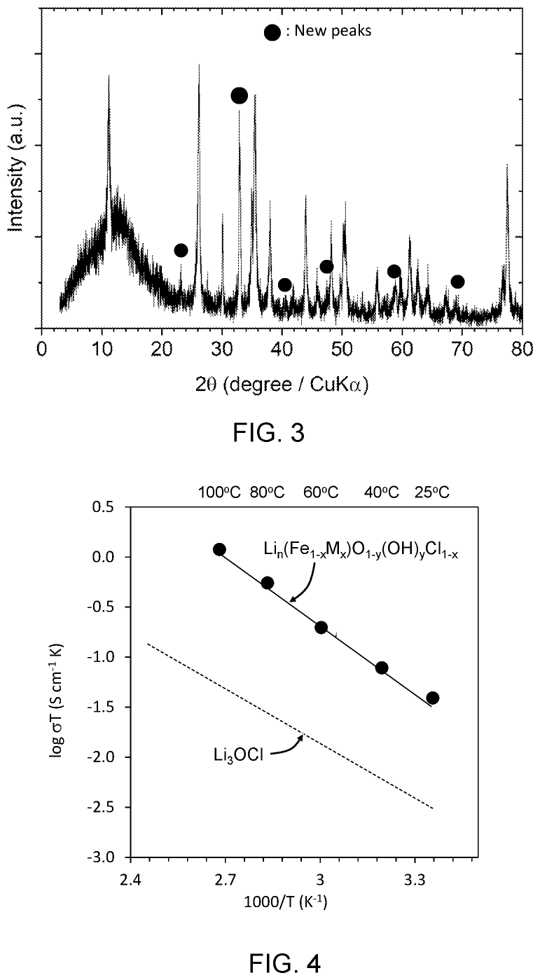

Referring to FIG. 3, a plot showing intensity versus angle 2θ for an XRD scan of the ionic conductor Li_{2-3x+y-z}FeₓO_{y}(OH)_{1-y}Cl_{1-z} formed according to Example 2 is shown. The black circles or dots in the figure identify peaks in the XRD scan that are not observed for the ionic conductor LiFeOCl. And as observed by the XRD scan in FIG. 3, the Li_{2-3x+y-z}FeₓO_{y}OH)_{1-y}Cl_{1-z.} compound has a crystal structure with additional XRD peaks between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°. In some variations, the additional XRD peaks represent the presence of one or more other inorganic compounds including but not limited to LiCl, Li(OH), Li₂CO₃, FeCl₃, FeCl₃(6H₂O), Fe(OH)₃, FeO, Fe₂O₃, Fe₃O₄, MgCl₂, MgCl₂(4H₂O), MgO, CaO, and Ca(OH).

Referring to FIG. 4, an Arrhenius plot of cationic conductivity versus temperature for the Li-ion conductor formed according to Example 2 and cationic conductivity versus temperature for the ionic conductor Li₃OCl is shown. Particularly, electrochemical cells formed according to Example 2 were subjected to AC impedance testing with an applied frequency range between 10⁶ to 10¹ Hertz using a Biologic VMP3 multichannel potentiostat/galvanostat with an impedance analyzer. In addition, the plot of the cationic conductivity versus temperature for the Li-ion conductor Li₃OCl was taken from the reference titled “Li-rich anti-perovskite Li₃OCl films with enhanced ionic conductivity” by Lu et al., Chem Commun (Camb). 2014 Oct 9; 50 (78):11520-2. doi: 10.1039/c4cc05372a. PMID: 25132213, which is incorporated herein by reference.

Still referring to FIG. 4, the Li-ion conductor according to the teachings of the present disclosure exhibited a cationic conductivity of about 1.4×10⁻⁴ S/cm at 25° C., about 2.6×10⁻⁴ S/cm at 40° C., about 6.0×10⁻⁴ S/cm at 60° C., about 1.6×10⁻³ S/cm at 80° C., and about 3.2×10⁻³ S/cm at 100° C. In contrast, the cationic conductivity for Li₃OCl per the reference noted above, was about 1.1×10⁻⁵ S/cm at 25° C., about 1.9×10⁻⁵ S/cm at 40° C., about 4.1×10⁻⁵ S/cm at 60° C., about 7.8×10⁻⁵ S/cm at 80° C., and about 1.4×10⁻⁴ S/cm at 100° C. Accordingly, in some variations the Li-ion conductor according to the teachings of the present disclosure has a cationic conductivity greater than or equal to 0.4×10⁻⁴ S/cm and less than or equal to about 2.4×10⁻⁴ S/cm at 25° C., greater than or equal to 1.6×10⁻⁴ S/cm and less than or equal to about 3.6×10⁻⁴ S/cm at 40° C., greater than or equal to 5.0×10⁻⁴ S/cm and less than or equal to about 7.0×10⁻⁴ S/cm at 60° C., greater than or equal to 0.6×10⁻³ S/cm and less than or equal to about 2.6×10⁻³ S/cm at 80° C., and/or greater than or equal to 2.2×10⁻³ S/cm and less than or equal to about 4.2×10⁻³ S/cm at 100° C. Also, the Li-ion conductors according to the teachings of the present disclosure exhibit a cationic conductivity that is about one order of magnitude greater than the traditional Li-ion conductor Li₃OCl.

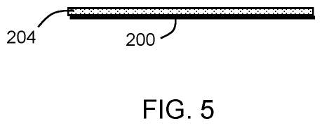

In view of the teachings of the present disclosure, it should be understood that a Li-ion conductor according to the teachings of the present disclosure exhibits enhanced cationic conductivity and/or thermal stability compared to traditional Li-ion conductors. In addition, in some variations a Li-ion conductor according to the teachings of the present disclosure is in the form of and/or part of a positive electrode coating layer 204 on a positive electrode 200 as illustrated in FIG. 5.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A lithium-ion conductor comprising:
an inorganic compound comprising:
a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25; and
x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°.

2. The lithium-ion conductor according to claim 1, wherein the inorganic compound further comprises at least one of FeCl₃, FeCl₃(6H₂O), Fe(OH)₃, FeO, Fe₂O₃, Fe₃O₄, MgCl₂, MgCl₂(4H₂O), MgO, CaO, and Ca(OH).

3. The lithium-ion conductor according to claim 1, wherein the inorganic compound has a thermal decomposition temperature greater than 390° C.

4. The lithium-ion conductor according to claim 1, wherein the inorganic compound comprises an ionic conductivity greater than about 1.0×10⁻⁴ S/cm at 25° C.

5. The lithium-ion conductor according to claim 1, wherein the inorganic compound comprises an ionic conductivity greater than about 2.0×10⁻⁴ S/cm at 40° C.

6. The lithium-ion conductor according to claim 1, wherein the inorganic compound comprises an ionic conductivity greater than about 5.0×10⁻⁴ S/cm at 60° C.

7. The lithium-ion conductor according to claim 1, wherein the inorganic compound comprises an ionic conductivity greater than about 1.0×10⁻³ S/cm at 80° C.

8. The lithium-ion conductor according to claim 1, wherein the inorganic compound comprises an ionic conductivity greater than about 2.5×10⁻³ S/cm at 100° C.

9. The lithium-ion conductor according to claim 1, wherein the inorganic compound comprises an ionic conductivity at least one order of magnitude of greater than an ionic conductivity of Li₃OCl.

10. The lithium-ion conductor according to claim 1 further comprising a positive electrode coating layer comprising the inorganic compound.

11. The lithium-ion conductor according to claim 1 further comprising a battery comprising the inorganic compound.

12. A lithium-ion conductor comprising:
an inorganic compound comprising:
a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25;
x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°; and
a thermal decomposition temperature greater than 390° C.

13. The lithium-ion conductor according to claim 12, wherein the inorganic compound further comprises at least one of FeCl₃, FeCl₃(6H₂O), Fe(OH)₃, FeO, Fe₂O₃, Fe₃O₄, MgCl₂, MgCl₂(4H₂O), MgO, CaO, and Ca(OH).

14. The lithium-ion conductor according to claim 12, wherein the inorganic compound comprises at least one of an ionic conductivity greater than about 2.0×10⁻⁴ S/cm at 40° C., an ionic conductivity greater than about 5.0×10⁻⁴ S/cm at 60° C., an ionic conductivity greater than about 1.0×10⁻³ S/cm at 80° C., and an ionic conductivity greater than about 2.5×10⁻³ S/cm at 100° C.

15. The lithium-ion conductor according to claim 12 further comprising a positive electrode coating layer comprising the inorganic compound.

16. The lithium-ion conductor according to claim 12 further comprising a battery comprising the inorganic compound.

17. A lithium-ion conductor comprising:
an inorganic compound comprising:
a chemical composition of Li_{2-3x+y-z}FeₓO_{y}(OH)_{1-y}Cl_{1-z}, where x is greater than or equal to 0 and less than 1, y is greater than or equal to 0 and less than or equal 1, and z is greater than or equal to 0 and less than or equal 0.25;
x-ray diffraction peaks with a 2θ between about 22.12° and about 24.12°, between about 31.97° and about 33.97°, between about 39.55° and about 41.55°, between about 46.46° and about 48.46°, between about 57.77° and about 59.77°, and between about 68.04° and about 70.04°;
a thermal decomposition temperature greater than 390° C.; and
an ionic conductivity greater than about 1.0×10⁻⁴ S/cm at 25° C.

18. The lithium-ion conductor according to claim 17, wherein the inorganic compound further comprises at least one of FeCl₃, FeCl₃(6H₂O), Fe(OH)₃, FeO, Fe₂O₃, Fe₃O₄, MgCl₂, MgCl₂(4H₂O), MgO, CaO, and Ca(OH).

19. The lithium-ion conductor according to claim 17 further comprising a positive electrode coating layer comprising the inorganic compound.

20. The lithium-ion conductor according to claim 17 further comprising a battery comprising the inorganic compound.
